(19) United States
(12) Patent Application Publication
(10) Pub. No.: US 2010/0324944 A1
(43) Pub. Date: Dec. 23, 2010

(54) INSURANCE CODE QUOTE RESOLUTION SYSTEM AND METHOD

(76) Inventor: Nagaraj V. RAO, Flower Mound, TX (US)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(21) Appl. No.: 12/488,681

(22) Filed: Jun. 22, 2009

(51) Int. Cl. G06Q 40/00

(52) U.S. Cl. 705/4

(57) ABSTRACT

An insurance code resolution system comprises a quotation module executable by a processor. The quotation module is configured to generate a quote request and submit the quote request to at least one insurance provider where the quote request comprises at least one code representing a parameter value for the quote. The quotation module is also configured to receive a response from the insurance provider associated with the quote request and, if the response indicates an inconsistency related to the at least one code, automatically initiate an action to modify the at least one code.

### BACKGROUND

Consumers looking for insurance products (e.g., automobile insurance, health insurance, life insurance, home insurance, etc.) often turn to the Internet or an insurance broker to obtain an insurance premium estimate (a.k.a., a rate quote). For example, a consumer may use the Internet to connect to the website of an insurance broker via a browser on a network-enabled computer. The consumer then enters one or more desired parameters related to the insurance product (e.g., deductible amount, coverage amount, type of automobile, etc.). After the parameters have been entered, the broker interfaces with different insurance providers and requests an insurance premium estimate or rate quote based on the desired parameters requested by the consumer. The rate quotes are then provided to the consumer. The information submitted to the insurance providers generally includes various codes representative of particular types of information (e.g., a code to identify a vehicle applicable to auto insurance, a code representative of a geographic territory where a home is located and/or where a vehicle is located, a code representative of a fire district, etc.).

### BRIEF DESCRIPTION OF THE DRAWINGS

The accompanying drawings incorporated in and forming a part of the specification illustrate several aspects of the present disclosure and, together with the description, serve to explain the principles of the present disclosure. In the drawings:

FIG. 1 is a schematic diagram illustrating an embodiment of an insurance quoting system;

FIG. 2 is a block diagram illustrating an embodiment of a server in the insurance quoting system of FIG. 1; and

FIG. 3 is a flow chart depicting an embodiment of an insurance quoting method.

### DETAILED DESCRIPTION OF THE DRAWINGS

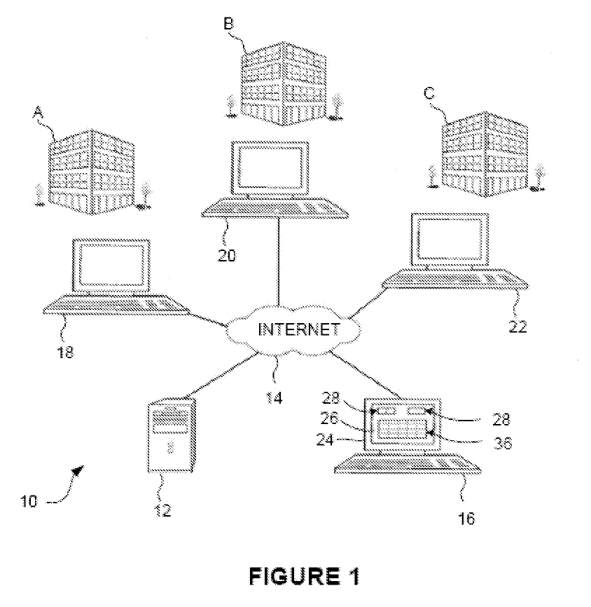

Referring now to FIG. 1, an embodiment of an insurance code quote resolution system 10 for providing insurance premium estimates to a user (e.g., consumer, potential customer, insurance agent, insurance broker etc.) and resolving code inconsistencies is illustrated. As will be more fully explained below, system 10 enables the user to interface with one or more insurance providers to obtain insurance premium estimates (a.k.a., rate quotes) from different insurance providers. System 10 also enables inconsistencies in codes used to identify various insurance parameters to be resolved. In the embodiment illustrated in FIG. 1, system 10 comprises a server 12 operably coupled through a network 14 to a computer 16 of a user, a computer 18 of insurance provider A, a computer 20 of insurance provider B, and a computer 22 of insurance provider C.

In the embodiment illustrated in FIG. 1, server 12 is a web server of an insurance broker. In some embodiments, server 12 is configured to receive requests through network 14 from a client such as, for example, computer 16. In that regard, server 12 may be equipped to accommodate data formatted as Hypertext Markup Language (HTML) and communicated using a standard communication protocol such as, for example, Hypertext Transfer Protocol (HTTP). Server 12 may be equipped for wireless communication, wired communication, or a combination thereof, over network 14. In some embodiments, server 12 is a computing device other than a web server. For example, server 12 may be a desktop or laptop computer or any other type of computing platform equipped with appropriate hardware and/or software. Also, while server 12 is depicted in FIG. 1 as receiving requests from a single client computer 16, additional client computers 16 may be present and accommodated by server 12. Multiple servers 12 may also be used.

In FIG. 1, network 14 is the Internet, which is a global system of interconnected computer networks that interchange data by packet switching using the standardized Internet Protocol Suite (TCP/IP). In some embodiments, network 14 may be another suitable network such as, for example, a wide area network (WAN), local area network (LAN), intranet, extranet, etc., or any combination thereof. Network 14 is configured to facilitate wireless communication, wired communication, or a combination thereof, between server 12, computer 16, computer 18, computer 20, and computer 22.

In FIG. 1, computer 16 is illustrated as a desktop personal computer (PC). However, it should be understood that computer 16 may be a variety of other network-enabled computing devices such as, for example, a server, laptop computer, notebook computer, tablet computer, personal digital assistant (PDA), wireless handheld device, cellular phone, and/or thin-client. Computer 16 is equipped for wireless communication, wired communication, or a combination thereof, over network 14.

In addition to other various types of software, computer 16 generally includes an Internet browser installed thereon. The browser of computer 16 is generally capable of displaying on a display 24 of the computer 16 an HTML document. In particular, the browser is capable of displaying an interface screen 26 (e.g., in the form of a graphical user interface (GUI)), which is based on the HTML document generated by server 12.

As shown in FIG. 1, interface screen 26 includes one or more input regions 28 where, for example, user profile information, a type of insurance, and one or more parameter values relating to the type of insurance may be input into computer 16 using a keyboard, mouse, or another input device. Input regions 28 may be configured, for example, as blank data fields, drop-down menus providing potential selections, a series of check boxes permitting the user to “check” a listed selection, or otherwise for receiving user profile information, a type of insurance and parameter values.

As used herein, user profile information may include, for example, the name, contact information, date of birth, and social security number of the user. Also, the type of insurance may include, for example, automobile, homeowners, business, disability, health and life insurance. In addition, parameters comprise one or more conditions generally related to a particular type of insurance. For example, parameters may include, for example, a deductible amount for insurance, a coverage amount for insurance, the state of residence of the user, an indication of whether or not the user is a tobacco user, the medical history of the user, the number of automobile accidents the user has been involved in the recent past, the number of traffic violations the user has had during a preceding time frame, the make, model and year of vehicle of the user, the age of the user, where the home/automobile is located and combinations thereof.

In some embodiments, user profile information, a type of insurance, and one or more parameters values are input into computer 16 by a user. The user may be a consumer/customer, an insurance broker/agent on behalf of a user/customer, or other individual. For example, in some embodiments, user profile information, a type of insurance, and one or more parameter values may be entered into computer 16 by an agent or employee of the insurance broker operating server 12. In those embodiments where the agent inputs data and information into computer 16, the agent may receive the information via telephone, electronic mail, facsimile, text message, regular mail, or other suitable transmission method.

Still referring to FIG. 1, the browser of computer 16 is capable of displaying on display 24 quote data 36. Quote data 36 includes insurance premium estimates from one or more insurance providers (e.g., insurance provider A, insurance provider B, and/or insurance provider C). These insurance premium estimates may be reviewed, compared and considered by the user of computer 16 who may be, for example, contemplating purchasing insurance from one of several different insurance providers based on the provided rate quotes. In some embodiments, the insurance premium estimates of quote data 36 may be conveyed to the consumer without employing the browser. For example, quote data 36 may be incorporated into an electronic mail message, included as an attachment to an electronic mail message, delivered via facsimile, sent as a text message, accessed through a hyperlink, or communicated using another format or method.

In addition to the above, the browser is capable of displaying a variety of other information on the display 24 of computer 16. Such information includes, but is not limited to, the name and contact information of each insurance provider giving an insurance premium estimate, the input parameters, a button or link permitting the direct purchasing of insurance from a particular insurance provider through the insurance broker, and a button permitting the page to be printed.

Even though generally not affiliated with one another, for the sake of convenience in the discussion below, each of computer 18, computer 20, and computer 22 in FIG. 1 may be collectively referred to as computers 18, 20 and 22 while their affiliated insurance providers may be collectively referred to as respective insurance providers A, B and C. Each of computers 18, 20 and 22 may be a server, web server, some type of personal computer (PC), or other computer device equipped with appropriate hardware and/or software for communication with server 12 through network 14. Also, while three computers 18, 20 and 22 and three insurance providers A, B and C are illustrated in FIG. 1, more or fewer computers and insurance providers may be accessible to server 12 through network 14.

Each of computers 18, 20 and 22 is equipped with software and/or hardware for generating insurance premium estimates based on a given parameter or set of parameter values. For example, a trial-calculation engine capable of calculating insurance premium estimates may be installed on computers 18, 20 and 22. The particular hardware and/or software on each of computers 18, 20 and 22 may be independently developed by the particular insurance provider A, B and C. In other words, each insurance provider A, B and C may have their own proprietary system, method, or algorithm for computing insurance premium estimates. Computers 18, 20 and 22 are each equipped for wireless communication, wired communication, or a combination thereof, over network 14. Further, hardware and/or software on each of computers 18, 20 and 22 may be configured to analyze submitted parameter information (e.g., various codes used to describe and/or identify various parameters) for compliance with general standards and/or the codes used by the particular insurance provider. In some embodiments, hardware and/or software on each of computers 18, 20 and 22 may be configured to respond and/or provide information regarding unrecognized codes and/or codes not in compliance with standard or provider-specific code rules.

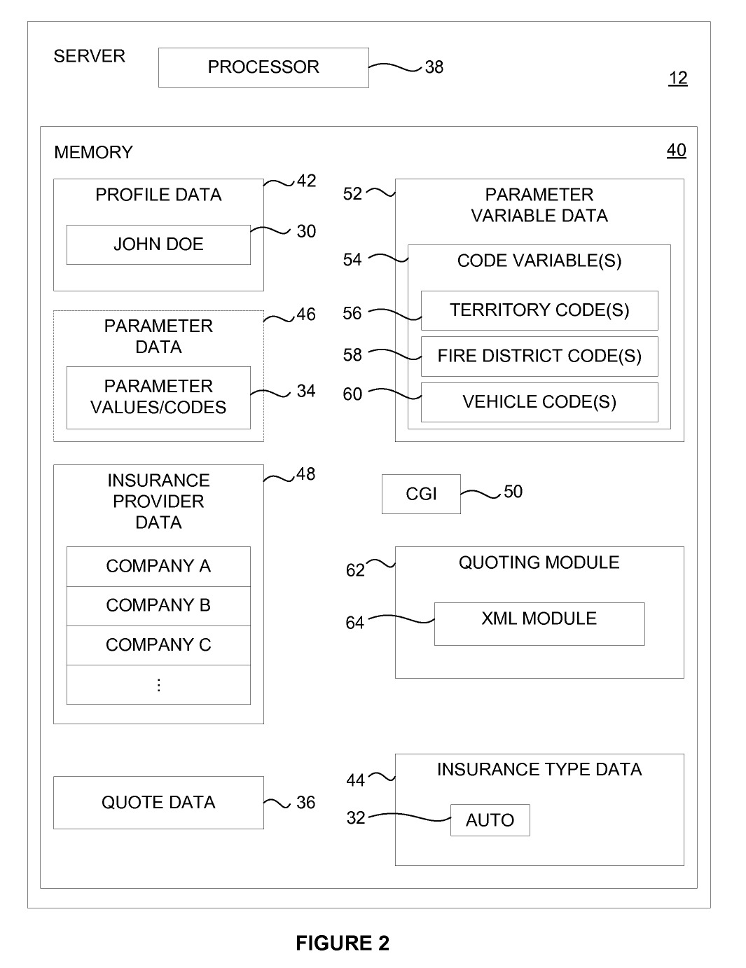

Referring now to FIG. 2, server 12 is illustrated in further detail. As shown, server 12 includes, among other things, a processor 38 and a memory 40. In general, processor 38 processes and/or executes instructions (e.g., software code) and performs logic calculations while memory 40 temporarily or permanently stores information that may be retrieved therefrom. In FIG. 2, memory 40 includes user profile data 42, insurance type data 44, and parameter data 46.

User profile data 42 comprises information associated with a particular user and/or customer seeking insurance rate quote(s). For example, in FIG. 2 user profile data 42 contains user profile data 30 for consumer John Doe. Insurance type data 44 comprises information associated with a desired type of insurance for which a rate quote is desired. For example, in FIG. 2, insurance type data 44 comprises information associated with an auto type 32 of insurance; however, it should be understood that different types of insurance information may be included/represented. Parameter data 46 comprises information associated with different parameters associated with a particular type of insurance for which a rate quote is desired. For example, in FIG. 2, for an auto type 32 of insurance, parameter data 46 comprises different parameter values/codes 34 corresponding to a deductible amount, a coverage amount, a code identifying the type of vehicle, the code identifying the location and/or fire district where the vehicle will be located, etc., for automobile insurance. Information included in user profile data 42, insurance type data 44 and/or parameter data 46 may be received from or selected by a consumer or an agent of the insurance broker operating server 12 using computer 16. For example, information associated with profile data 42 may be input by a user or broker using computer 16 and stored by server 12 as profile data 42. Further, a particular type of insurance may be selected by a user/broker and, based on the selection, different parameters associated with the selected type of insurance provided to the user/broker for input/selection. The type of insurance and selection of parameter values are stored by server 12 as insurance type data 44 and parameter data 46. It should be understood various types of information associated with the type of insurance and parameter values/codes for a particular type of insurance may be pre-stored in memory 40 and presented to the user/broker through one or more input screens or data entry interfaces.

Memory 40 also includes insurance provider data 48. Insurance provider data 48 comprises information associated with different providers of insurance offerings (e.g., Companies A, B and C). The information stored as insurance provider data 48 may be predefined and stored in memory 40 (e.g., indicating that particular insurance providers offer particular insurance types). It should be understood that insurance provider data 48 may be obtained by server 12 communicating with computers 18, 20 and 22 via network 14 to inquire whether insurance providers (e.g., insurance providers A, B and C) offer a particular type of insurance. In some embodiments, polling of insurance providers may be made to determine the different types of insurance offered by different providers. Information associated with different insurance providers may also be automatically updated in response to updates automatically received from computers 18, 20 and 22 (e.g., without a prompt or request from server 12). In some embodiments, information may be collected from insurance providers according to a predetermined schedule to periodically update information stored in memory 40. Because of an interface and/or data transferred between server 12, computer 18, computer 20, and computer 22, memory 40 may also include a common gateway interface (CGI) 50. CGI 50 has the ability to receive and process non-standardized data from multiple sources and to output standardized data. In particular, CGI 50 of server 12 may be configured to output a document or data, such as parameter data 46 and profile data 42, in an HTML, XML or any other type of format to facilitate communications with computers 18, 20 and 22, receive information such as rate quotes from computers 18, 20 and 22, and transfer such information to quotation module 62.

Memory 40 also comprises parameter variable data 52 comprising information associated with variables associated with each parameter corresponding to a particular type of insurance. For example, for automobile insurance, parameter variables may include a deductible amount, a coverage limit, the type of automobile, the number of previous accidents or claims for a certain time period, etc. In the embodiment illustrated in FIG. 2, parameter variable data 52 comprises code variable(s) 54. Code variable(s) 54 comprises information corresponding to codes that may be used by the insurance providers to describe and/or otherwise identify different types of variables for determining and/or calculating an insurance quote. For example, in the illustrated embodiment, code variable(s) 54 comprise territory code(s) 56, fire district code(s) 58 and vehicle code(s) 60. Territory code(s) 56 includes one or more codes used to identify a particular geographic location related to the type of insurance such as, but not limited to, the location of a home for homeowner insurance, the location or primary residence location of an automobile for automobile insurance, etc. Fire district code(s) 58 includes one or more codes used to identify a particular fire district related to the particular type of insurance such as, but not limited to, the fire district where a home is located or where the primary residence of an automobile is located. Vehicle code(s) include one or more codes used to describe and/or otherwise identify a particular type (e.g., make, model, options package) of vehicle. It should be understood that code variable(s) may comprise other types of codes corresponding to different types of variable and/or different types of insurance.

It should be understood that different insurance providers may use different codes for particular parameters. As an example, for insurance company A, the vehicle code 60 for a particular pickup truck model may be F150, while insurance company B may use F-150, while insurance company C may use F/150. Thus, information submitted to particular insurance providers may conflict with the codes used by such insurance providers, thereby resulting in the inability of the insurance provider to analyze the request and provide a quote.

Parameter variable data 52 may be obtained in a variety of different ways. For example, in some embodiments, stored parameter variable data 52 may be based on previous successful rate quote request submissions to particular insurance providers (e.g., automatically stored in response to receiving a rate quote from a particular insurance provider). In some embodiments, insurance companies A, B and C may be polled to acquire parameter variable data 52. In some embodiments, parameter variable data 52 may be predefined and/or pre-stored in memory 40 (e.g., based on information entered/stored by a broker/agent). Stored parameter variable data 52 may also be insurance provider-dependent (e.g., a different code for different insurance providers where each different code corresponds essentially to the same parameter value, such as the identification of a particular automobile make/model).

Memory 40 also has stored therein quotation module 62. Quotation module 62 functions to interface with computers 18, 20 and/or 22 and obtain insurance premium estimates/quotes from insurance companies A, B and/or C. In some embodiments, quotation module 62 is software (e.g., a set of instructions and/or an algorithm) that, when executed by processor 38, generates and/or otherwise provides interface screen 26, automatically obtains rate quotes from insurance providers. In other embodiments, quotation module 62 is some combination of software, hardware, and/or firmware. In some embodiments, quotation module 62 analyzes responses received from insurance providers and automatically responds to code inconsistencies/nonconformities to resolve the code inconsistency/nonconformity (e.g., insurance providers A, B and/or C). For example, in some embodiments, quotation module 62 automatically varies and/or otherwise modifies a particular code included in the quote request in response to an indication from the particular insurance provider that the code is unrecognized and/or is noncompliant with that provider's recognized code (e.g., by selecting another code used to identify essentially the same parameter value from code variable(s) 54). In some embodiments, quotation module 62 notifies and/or otherwise alerts a user of the code nonconformance and requests modification of the code. In further embodiments, quotation module 62 provides a user with selectable options for modifying a particular code (e.g., retrieving alternate codes from memory 40 and displaying such alternate codes to the user for selection by the user).

In the embodiment illustrated in FIG. 2, quotation module 62 comprises an XML module 64. XML module 64 may comprise software, hardware, firmware, or a combination thereof. In some embodiments, XML module 64 comprises a set of executable instructions and/or an algorithm to prepare and submit the quote request to insurance providers in XML format. In the illustrated embodiment, XML module 64 is part of quotation module 62; however, it should be understood that XML module 64 may be separate and distinct from quotation module 62. Further, in this embodiment, XML module 64 may comprise an interface for receiving and/or formatting information in an XML format such that information may be accessed by quotation module 62 for submission to insurance providers.

Thus, in operation, a user selects and/or otherwise inputs profile data 42, the type of insurance for which a rate quote is desired (e.g., insurance type data 44) and a value for each of the parameters corresponding to the selected insurance type (e.g., parameter data 46) in interface screen 26 and such information is electronically transmitted to server 12. Quotation module 62 accesses profile data 42, insurance type data 44, and parameter data 46 and formulates and/or otherwise generates a request for a rate quote and submits and/or otherwise electronically communicates the rate quote request to one or more insurance providers. Quotation module 62 receives the rate quote information from the respective insurance providers and stores the rate quote information in memory 40 as quote data 36.

Additionally, quotation module 62 analyzes information received from insurance providers in response to any indications that one or more codes used to identify particular parameters is inconsistent or noncompliant with a code recognized or used by the particular insurance provider. For example, in some embodiments, quotation module 62 automatically revises the discrepant code and resubmits and/or otherwise communicates the rate quote request to a particular insurance provider. The above process may be repeated for one or more insurance providers for one or more different parameter codes. Further, quotation module 62 may be configured to respond to a single code inconsistency and resubmit the rate quote request or address multiple code inconsistencies before resubmitting the rate quote request. For example, in some embodiments, a response from the insurance provider may indicate a single code inconsistency such that the insurance provider processes each parameter variable in sequence and as soon as a code inconsistency is discovered, the insurance provider responds identifying the inconsistency before processing the remainder of the rate quote request. Thus, in this example, quotation module 62 may be configured to respond to a single code inconsistency and resubmit the rate quote request. In other embodiments, the insurance provider may process the entire or a significant portion of the rate quote request and respond identifying one or more code inconsistencies. In this example, quotation module 62 may be configured to address each code inconsistency identified (e.g., even multiple code inconsistencies) and resubmit the rate quote request after addressing each of the identified inconsistencies.

In the embodiment illustrated in FIG. 2, quotation module 62, memory 40, and processor 38 reside on server 12. However, in some embodiments, quotation module 62, memory 40, and/or processor 38 may be embodied within computer 16 in lieu of server 12. Also, in some embodiments, either or both of memory 40 and processor 38 may be incorporated into another device and remotely located relative to server 12 and/or computer 16. In some embodiments, quotation module 62 is stored on a tangible, computer-readable medium such as, for example, a compact disk (CD), a digital versatile disk (DVD), which is sometimes referred to as a digital video disk, a flash drive, and the like. Further, it should be understood that quotation module 62, and the information used by quotation module 62 (e.g., parameter variable data 52, parameter data 46, insurance provider data 48) may be located remote from server 12 and/or processor 38.

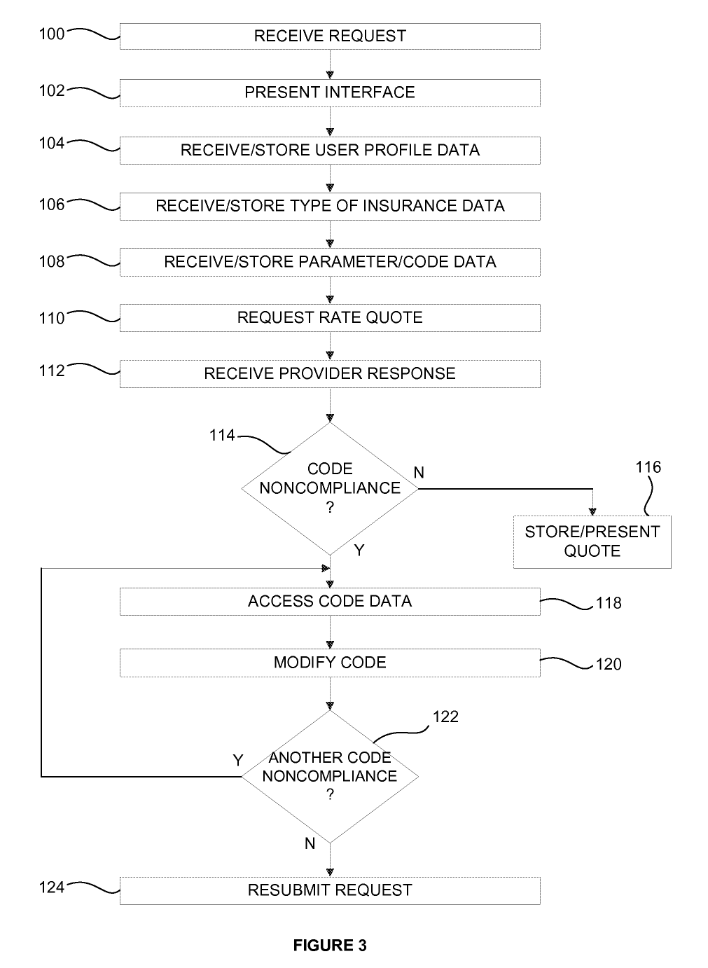

FIG. 3 is a flow diagram illustrating an embodiment of a method for providing insurance premium estimates from insurance providers. At block 100, server 12 receives a service request initiated by the user via the browser on computer 16. The service connection request received by server 12 may be initiated by, for example, the user inputting into the browser on computer 16 the uniform resource locator (URL) of the website of the insurance broker operating server 12.

At block 102 quotation module 62 is executed by processor 38 of server 12 to present the interface screen 26 to the user on display 24 of computer 16. With a keyboard, mouse, or another suitable input device, the user inputs, through input regions 28 of interface screen 26, user profile data 30. Thereafter, user profile data 30 is transmitted through network 14 to server 12. At block 104, server 12 receives and stores user profile data in memory 40.

Quotation module 62 prompts and/or otherwise requests the user to input, through input regions 28 of interface screen 26, an indication of the type of insurance for which a rate quote is desired. Thereafter, the type of insurance associated with the rate quote request is transmitted through network 14 to server 12 and stored as insurance type data 44 in memory 40 at block 106. Quotation module 62 prompts and/or otherwise requests the user to input, through input regions 28 of interface screen 26, one or more parameter values/codes for each of the parameters pertaining to the indicated/selected type of insurance. For example, if the type of insurance selected/indicated is automobile insurance, the user may input a deductible amount, a desired coverage amount, a vehicle code 60, and/or other parameter values/codes. Thereafter, the parameter values/codes are transmitted through network 14 and stored by quotation module 62 as parameter data 46 in memory 40.

Quotation module 62 generates and/or otherwise formulates a request for a rate quote using the profile data 42 and the parameter data 46 and communicates/transmits the request at block 110 to one or more insurance providers (e.g., communicating with one or more of computers 18, 20 and 22). For example, in some embodiments, quotation module 62 accesses insurance provider data 48 to identify insurance providers offering the particular type of insurance, insurance providers registered with server 12 offering on-line rate quotes, insurance providers offering real-time or near real-time rate quotes, and/or another criteria indicating that the request may/should be transmitted to the corresponding insurance provider. In some embodiments, quotation module 62 may enable a user and/or broker to select and/or otherwise identify the insurance providers to receive the request for rate quote. At block 112, quotation module 62 receives a response from the respective insurance providers.

At decisional block 114, quotation module 62 assesses the response(s) received from the respective insurance providers and determines whether the respective responses are in the form of a rate quote or whether the responses provide an indication that one or more codes used to specify a particular parameter is nonconforming. If the response is in the form of a rate quote, the method proceeds to block 116, where the rate quote is stored in memory 40 (e.g., as quote data 36) and/or presented to the user (e.g., displayed). If any of the responses indicate that one ore more codes are nonconforming, the method proceeds to block 118, where quotation module 62 accesses code variable(s) 54, and at block 120 varies/modifies the respective code. However, it should be understood that in some embodiments, an indication of the nonconforming code may be provided to the user (e.g., a display prompt) to enable the user to select and/or modify the respective code.

At block 122, quotation module determines whether additional codes are noncompliant in the rate quote request. If additional codes need to be revised and/or otherwise modified, the method proceeds to block 118. If no additional codes need to be revised/modified, the method proceeds to block 124 where quotation module 62 resubmits the rate request to the respective insurance provider. Further, it should be understood that the method depicted by blocks 112, 114, 118, 120 and 122 may be carried out independently of one another as to different insurance providers (e.g., different requests may be submitted to different insurance providers with different parameter values at different times). The requests for rate quotes and code modifications may also be submitted simultaneously or substantially simultaneously to multiple insurance providers.

It should be understood that in the described method, certain functions may be omitted, accomplished in a sequence different from that depicted in FIG. 3, or simultaneously performed. Also, it should be understood that the method depicted in FIG. 3 may be altered to encompass any of the other features or aspects as described elsewhere in the specification. Further, embodiments may be implemented in software and can be adapted to run on different platforms and operating systems. In particular, functions implemented by quotation module 62, for example, may be provided as an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium.

What is claimed is:

1. An insurance code resolution system, comprising:
a quotation module executable by a processor, the quotation module configured to generate a quote request and submit the quote request to at least one insurance provider, the quote request comprising at least one code representing a parameter value for the quote, the quotation module configured to receive a response from the insurance provider associated with the quote request and, if the response indicates an inconsistency related to the at least one code, automatically initiate an action to modify the at least one code.

2. The system of claim 1, wherein the quotation module is configured to display at least one alternate code for the at least one code.

3. The system of claim 1, wherein the quotation module is configured to automatically modify the at least one code independent of user intervention.

4. The system of claim 1, wherein the quotation module is configured to prompt a user requesting an alternate code for the at least one code.

5. The system of claim 1, wherein the quotation module is configured to receive from a user an alternate code for the at least one code.

6. The system of claim 1, wherein the quotation module is configured to generate the quote request in XML format.

7. The system of claim 1, wherein the quote request comprises at least one of a territory code and a fire district code.

8. The system of claim 1, wherein the quote request comprises a territory code, and wherein the quotation module is configured to automatically modify the territory code and resubmit the quote request with the modified territory code.

9. The system of claim 1, wherein the quote request comprises a fire district code, and wherein the quotation module is configured to automatically modify the fire district code and resubmit the quote request with the modified fire district code.

10. An insurance code resolution method, comprising:
electronically transmitting a quote request to at least one insurance provider, the quote request comprising at least one code representing a parameter value for the quote;
receiving a response to the quote request from the at least one insurance provider; and
if the response indicates an inconsistency related to the at least one code, automatically initiating an action to modify the at least one code.

11. The method of claim 10, further comprising displaying at least one alternate code for the at least one code.

12. The method of claim 10, further comprising automatically modifying the at least one code independent of user intervention.

13. The method of claim 10, further comprising prompting a user requesting an alternate code for the at least one code.

14. The method of claim 10, further comprising generating the quote request in XML format.

15. A computer program product having stored thereon an instruction set to be executed by a processor, the instruction set, when executed by the processor, causes the processor to:
electronically transmit a quote request to at least one insurance provider, the quote request comprising at least one code representing a parameter value for the quote;
receive a response to the quote request from the at least one insurance provider; and
if the response indicates an inconsistency related to the at least one code, automatically initiate an action to modify the at least one code.

16. The computer program product of claim 15, wherein the instruction set, when executed by the processor, causes the processor to display at least one alternate code for the at least one code.

17. The computer program product of claim 15, wherein the instruction set, when executed by the processor, causes the processor to automatically modify the at least one code independent of user intervention.

18. The computer program product of claim 15, wherein the instruction set, when executed by the processor, causes the processor to prompt a user requesting an alternate code for the at least one code.

19. The computer program product of claim 15, wherein the instruction set, when executed by the processor, causes the processor to automatically modify the at least one code and resubmit the quote request to the insurance provider with the modified at least one code.

20. The computer program product of claim 15, wherein the instruction set, when executed by the processor, causes the processor to modify each of a plurality of identified inconsistent codes before resubmitting the quote request to the insurance provider.
